(19) United States
(12) Patent Application Publication
(10) Pub. No.: US 2013/0000168 A1
(43) Pub. Date: Jan. 3, 2013

(54) MOTION ENHANCED SIGN AND METHOD OF PROVIDING INFORMATION

(75) Inventor: Jacob Andersen, Liberty Lake, WA (US)

(73) Assignee: Andersen Holdings, LLC, Liberty Lake, WA (US)

(21) Appl. No.: 13/282,405

(22) Filed: Oct. 26, 2011

Related U.S. Application Data
(60) Provisional application No. 61/504,189, filed on Jul. 2, 2011.

(51) Int. Cl. G09F 19/02; G09F 21/02

(52) U.S. Cl. 40/586

(57) ABSTRACT

The present disclosure relates to motion enhanced sign apparatuses and methods for providing information such as advertising using a motion enhanced sign apparatus.

### BACKGROUND

The movement and spinning of signs has been an advertising technique of growing popularity to attract the attention of consumers. Previously, a sign might be held by a person who would stand proximate to road to direct passersby, such as car occupants, pedestrians, and cyclists toward a particular business or to provide other information, such as protest slogans, the promotion of a political candidate for office, and so forth. In some instances, the sign holder will throw, spin, and otherwise manipulate the sign in order to attract additional attention. The present disclosure relates to enhancing a sign with motion for informational purposes such as advertising, promotion, information, or other reference.

### BRIEF DESCRIPTION OF THE DRAWINGS

FIG. 1 is a side profile view of an exemplary implementation of a motion enhanced sign apparatus.

FIG. 2 is a perspective view of the exemplary implementation of the motion enhanced sign apparatus of FIG. 1.

FIG. 3 is a rear and side profile view of the exemplary implementation of the motion enhanced sign apparatus of FIGS. 1 and 2.

FIG. 4 shows a rear and cutaway view of an exemplary motion enhancing component for use in the motion enhanced sign apparatus of FIGS. 1-3.

FIG. 5 shows a rear and cutaway view of an alternative motion enhancing component for use in a motion enhanced sign apparatus.

FIG. 6 shws a perspective view of an exemplary implementation of a motion enhanced sign apparatus.

FIG. 7 shows a perspective view of an exemplary implementation of motion enhanced sign apparatus that is configured to present multiple signs.

FIG. 8A shows a top view of the exemplary implementation of FIG. 7. [Jacob: I didn't add numbers yet as we will need a slightly scaled down version of these]

FIG. 8B shows a side view of the exemplary implementation of FIG. 7.

FIG. 9 shows a perspective view of an exemplary implementation of motion enhanced sign apparatus that is configured to present multiple signs and to provide coordinated motion of the multiple signs.

FIG. 10 shows a perspective view of an exemplary implementation of an additional or alternative motion provided by a motion enhanced sign apparatus.

In the following detailed description, reference is made to the accompanying schematic drawings, which form a part hereof. The use of the same symbols in different drawings typically indicates similar or identical items. The illustrative embodiments described in the detailed description, drawings, and claims are provided merely for illustration and are not meant to be limiting. Other embodiments may be utilized, and other changes may be made, without departing from the spirit or scope of the subject matter presented here.

### DETAILED DESCRIPTION

An exemplary apparatus according to one implementation described herein includes a sign containing advertising or informational content, a handle and/or extended portion configured to allow a user to hold or steady the sign, and a motion enhancing mechanism configured to attach the sign to the handle or extended portion and to allow motion of the sign relative to the handle or extended portion. According to one implementation, the motion enhancing mechanism comprises a spinning mechanism, such as a bearing, to allow the sign to spin relative to the handle or extended portion. According to another implementation, the motion enhancing mechanism comprises a ball joint or pivot to allow the sign to spin and tilt relative to the handle or extended portion in multiple directions. The extendable portion may be configured to engage a surface, such as a table or a ground level surface, to support the weight of the apparatus. The apparatus may also have a locking mechanism to releasably lock the sign relative to the extended portion. The apparatus may further be configured to present multiple signs alternatively or simultaneously. Further details of the exemplary implementations are described below with reference to the figures.

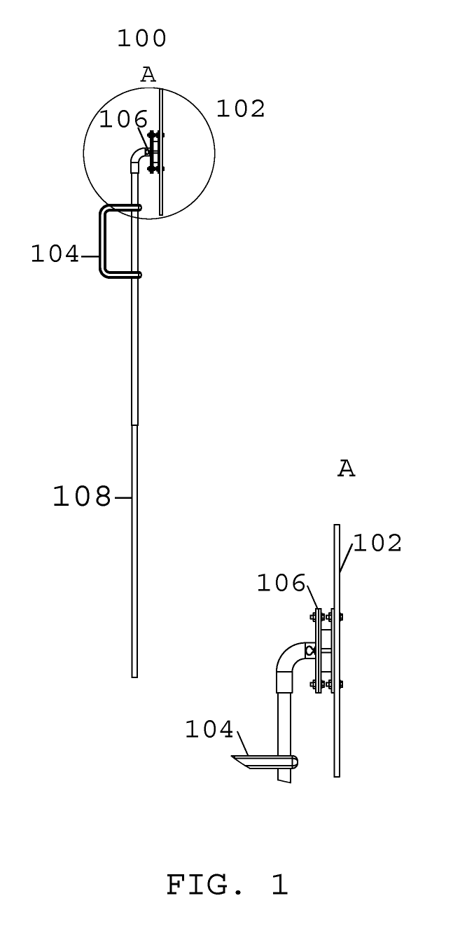

FIG. 1 illustrates an exemplary apparatus 100 according to one implementation that includes a sign 102 containing advertising or informational content. The apparatus 100 may further include a handle 104 configured to allow a user to hold or steady the sign 102, and a motion enhancing mechanism 106 configured to attach the sign 102 to the handle and to allow motion of the sign 102 relative to the handle 104.

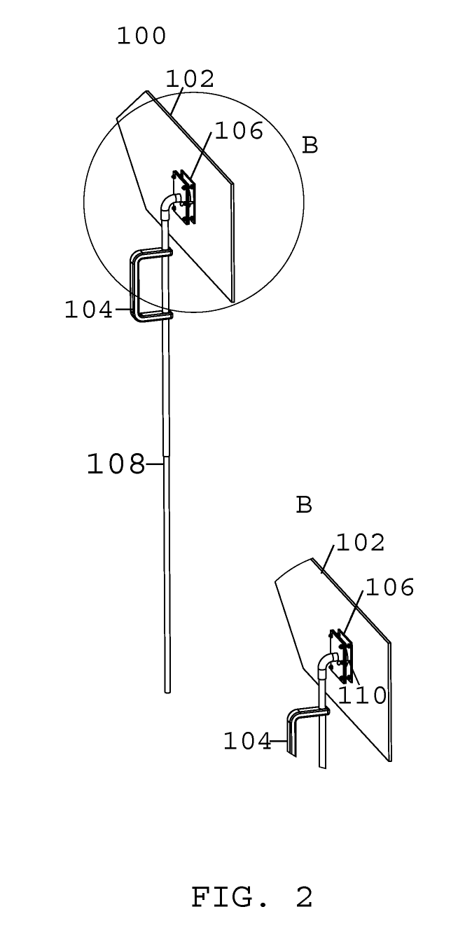

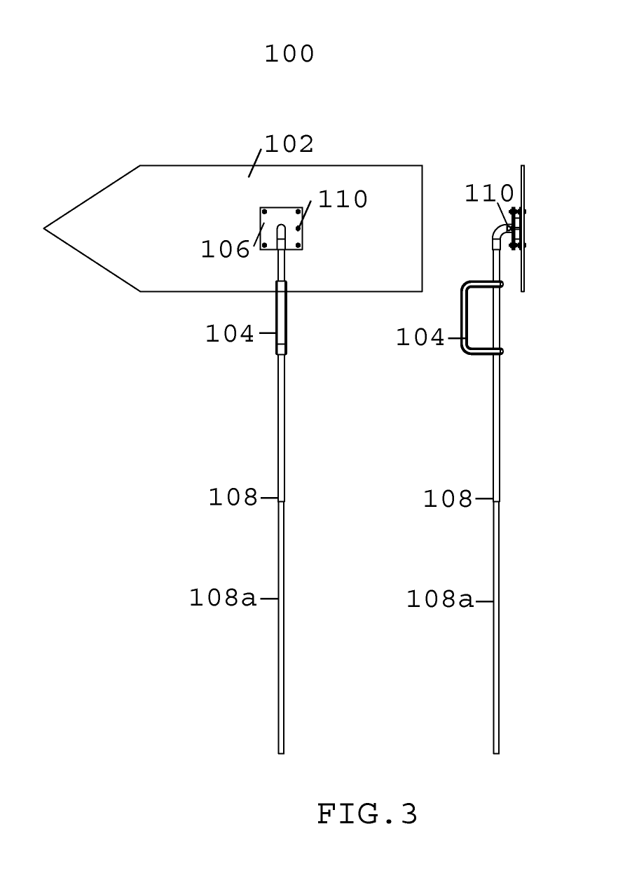

As further shown with further reference to FIGS. 2 and 3, the sign 102 may be generally flat, and of any suitable thickness, shape, or design. However, it is appreciated that the sign may have three dimensional features and aspects depending on the application and/or user preferences. The sign may be used for advertising or for the display of information. According to one example, the sign maybe used by a user along a road, trail, or other thoroughfare to attract attention of passing vehicular and/or pedestrian traffic.

According to an implementation, the apparatus 100 has a handle 104 to allow a user to hold the sign. In one example, the handle may have a U-shaped portion or other configuration to allow the user to hold the apparatus in a position offset from the main axis of the handle 104. Additionally or alternatively, a handle 104 may be integrated with a pole or other extended portion 108. In an example, the handle 104 may include, be attached to, or be integrated with, an extended portion 108 configured to engage a surface, such as a table or a ground level surface, to support the weight of the apparatus and, in some implementations, a U-shaped portion to engage with a user's hand. In one example, the extended portion 108 has a single position and length. In an alternative implementation, the extended portion 108 may be adjustable, via e.g., extension 108a, to adjust the height of the sign 102 relative to a surface, such as a table or a ground surface. The extended portion 108 may be configured to engage a stand, flag pole mount, or other engagement mechanism to maintain the pole in a desired position, such as upright or extending from a building or other structural element. According to these implementations, the sign 102 may be displayed even though there is not user to hold the extended portion and or handle 104. While the handle 104 and extended portion 108 are shown having generally round cross-sections, it is intended that portions or the entireties of either or both the handle 104 and the extended portion may have an elongated, oval, square, rectangular, teardrop, ergonomic, or other suitable cross-sectional shape.

The extended portion 108 and motion enhancement mechanism 106 allow a user to hold and provide motion to signs of various sizes, shapes, and weights. Moreover, the ability of a user to enhance advertising techniques using particularly large, particularly bulky, and/or particularly heavy signs is increased as the user can steady and support the sign with the extended portion 108. Moreover, the mechanical advantages of the extended portion 108 and motion enhancement mechanism 106 may allow a user of more diminutive size and/or strength to advertise with larger or heavier signs than previously possible. Still further, the extended portion 108 allows a user to provide motion enhanced sign advertise for potentially longer periods of time as the user does not have to support the full weight of the sign. The extended portion 108 also advantageously allows a user to sway the extended portion 108 in various directions, thereby generating an additional, or alternative, motion to that provided by the motion enhancing mechanism 106, which further enhances the advertising effect.

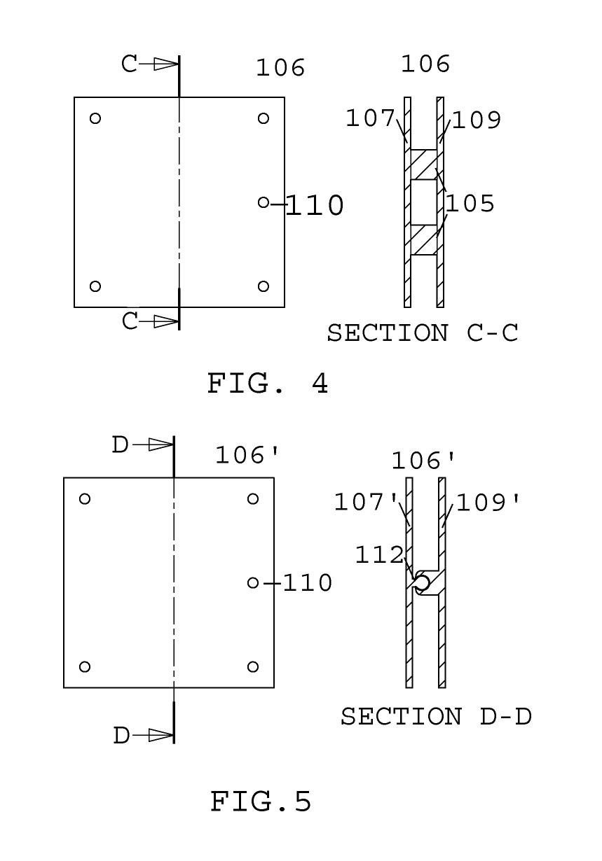

According to an implementation shown in FIG. 4, the motion enhancing mechanism 106 comprises a spinning motion enhancing mechanism 106 to allow the sign 102 to spin relative to the handle. The spinning motion enhancing mechanism 106 may include a bearing 105, such as a ball bearing or needle bearing mechanism, an axle-based spinning mechanism, or any other suitable conventional mechanism to allow one component to spin relative to another component. The motion enhancing mechanism 106 may further include a first mounting mechanism 107 for mounting the motion enhancing mechanism 106 to the handle 104 and a second mounting mechanism 109 for mounting the motion enhancing mechanism 106 to the sign 102.

According to one implementation, the handle 104 and extended portion 108 extend longitudinally in a first direction. The motion enhancing mechanism 106 is configured to allow the sign 102 to move in a second direction, which may be the same or different than the first direction. For example, the motion enhancing mechanism may be configured to allow the sign 102 to spin along an axis in a second direction that is different than the first direction. The second direction may be perpendicular to the first direction or may be any suitable direction as warranted by particular application.

As further shown in FIGS. 1-5, the motion enhancing mechanism 106 may include a locking mechanism 110. According to one implementation, the locking mechanism 110 maybe a spring loaded pin or other device that engages a notch (not shown) associated with the sign 102 in order to prevent motion of the sign 102 relative to the handle 104. Of course, the locking mechanism 110 could take any form that would prevent some motion of the sign 102 relative to the handle 104.

According to another implementation, a motion enhancing mechanism 106′ comprises a ball joint 112 or other angle adjustment mechanism to allow the sign 102 to spin and tilt relative to the handle 104. One portion of the ball joint 112 may be coupled, or integrated, with a first mounting mechanism 107′ for mounting the motion enhancing mechanism 106′ to the handle 104. A second portion of the ball joint 112 may be coupled, or integrated, with a second mounting mechanism 109′ for mounting the motion enhancing mechanism 106′ to the sign 102.

Furthermore, the bearing based motion enhancing mechanism 106 may be mounted to the handle 104 using a hinge, ball joint, or other mechanism to allow the sign 102 to be tilted relative the handle 104 and to allow the sign 102 to spin in the tilted position. The motion of the sign may be automated. For example, the sign may be provided with features or shapes (not shown), such as angles, slots, or propellers that allow the sign 102 to automatically spin when wind blows on the sign. Alternatively, a small motor (not shown) may be provided to automate the motion of the sign 102.

While the handle 104 and extended portion 108 are shown having generally round cross-sections, it is intended that portions or the entireties of either or both the handle and the extended portion may alternatively have an elongated, oval, square, rectangular, teardrop, ergonomic, or other suitable cross-sectional shape.

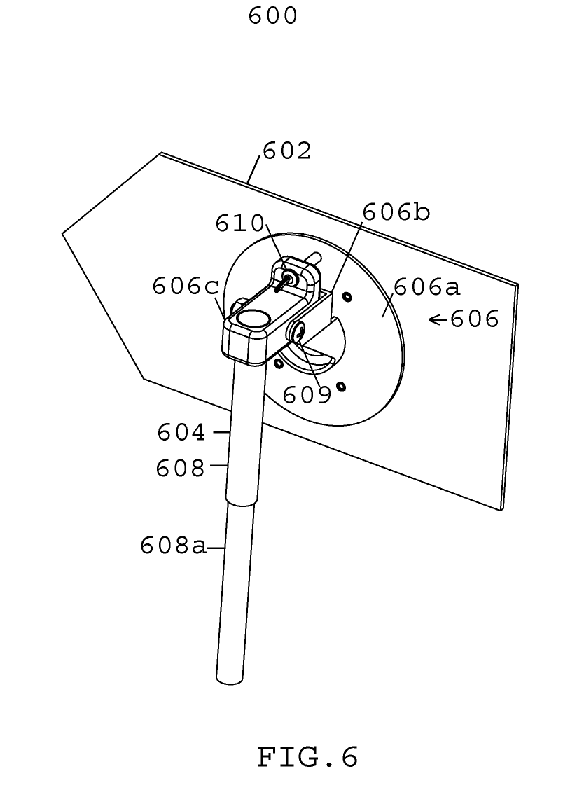

FIG. 6 illustrates an implementation of an apparatus 600 in which the motion enhancing mechanism 606, comprising a first component 606a and a second component 606b, is operable to be angularly adjusted with regard to the handle 604, where the handle 604 is shown integrated with the extended portion 608. The integrated handle 604 may generally be any area of the extended portion 608 in which a user may grab or hold the extended portion 608. As set forth above, the extended portion 608 may be of a fixed length such that it statically extends in a longitudinal direction away from the motion enhancing mechanism 606. The extended portion 608 may alternately be extendable and may have, for example, one or more extendable portions 608a to allow the extended portion 608 to be adjustably extended. It is to appreciated, however, that according to certain implementations, adjustable extendibility of the extending portion 608 is not required. While the integrated handle 604 and extended portion 608 are shown having generally round cross-sections, it is intended that portions or the entireties of either or both the handle and the extended portion may alternatively have an elongated, oval, square, rectangular, teardrop, ergonomic, or other suitable cross-sectional shape.

Motion enhancing mechanism 606 may be configured to engage with a sign, e.g. sign 602, through one more securing mechanisms, such as, for example, glue, hook-and-loop fastener, rivet, adhesive, staple, or any other mechanism for securing sign 602 directly or indirectly to motion enhancing mechanism 606. A first component 606a may spin or otherwise move relative to a second component 606b which allows the sign to spin or otherwise move relative to the handle 604 and/or extended portion 608. The spinning motion or movement may be due to a bearing, wound spring, or other spinning mechanism (not shown) operating between the first component 606a and second component 606b.

The motion enhancing mechanism 606 may have a third component 606c, which may be configured to allow movement between the second component 606b and third component 606c. As shown in FIG. 6, for example, the combination of the second component and third component 606c may allow the sign to be tilted or angled relative to the handle 604 and/or extended portion 608. The angle may be adjusted using an adjustment mechanism 609, which may include a pin, knob, screw, bolt, or other mechanism for adjusting the angle between the second component 606b and third component 606c. Although a vertical angle adjustment is shown, a horizontal angle adjustment or other angle adjustment may additionally or alternatively be provided as would be appreciated by one skilled in the art. Moreover, the third component 606c of the motion enhancing mechanism 606 may be fixedly or rotatably attached directly or indirectly to the extended portion 108.

The sign 602, and the first component 606a, may be selectively fixed relative to the second component 606b of the motion enhancing mechanism by use of locking mechanism 610. The locking mechanism 610 may allow the sign 602 to be selectively locked in place relative to the extended portion 608 or selectively released to allow the sign 602 to spin freely.

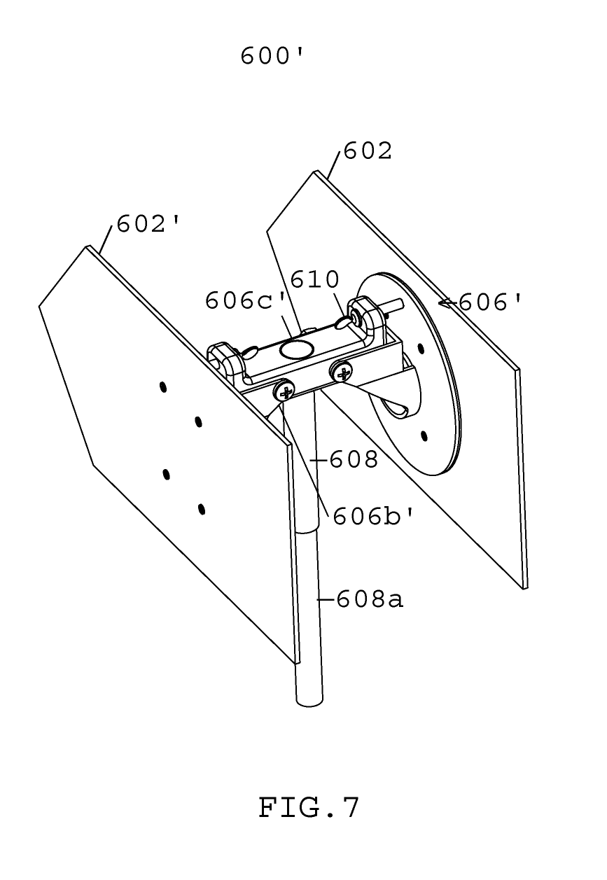

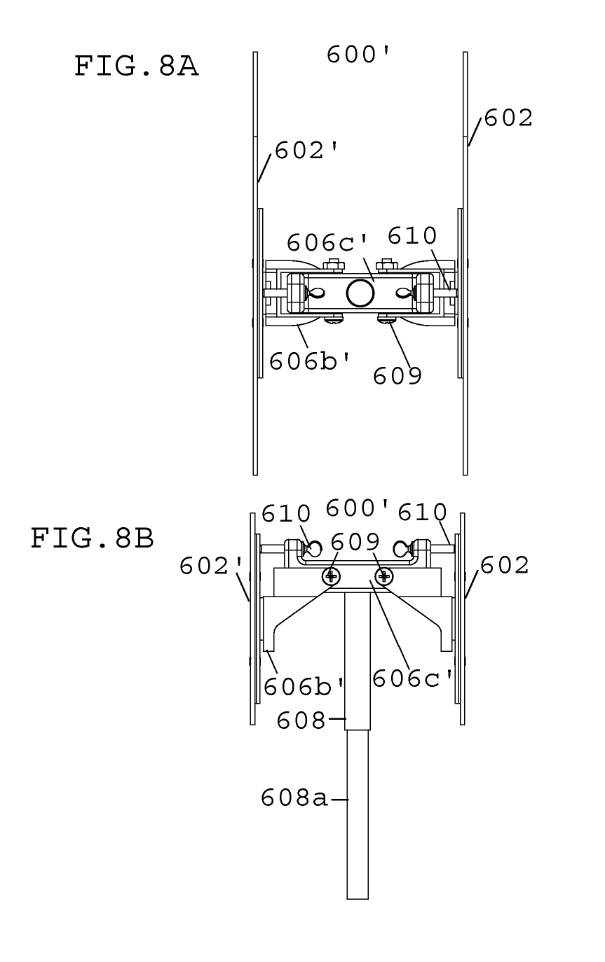

According to the implementation shown in FIGS. 7, 8A, and 8B, at least one additional sign 602′ may be presented or displayed using the apparatus 600′. The apparatus 600′ may be generally similar to apparatuses 100 and 600, described above with regard to FIGS. 1-6, but may have a third component 606c′ of the motion enhancing component 606′ that is configured to accommodate two or more signs 602, 602′, and so forth. Thus, although only two signs are illustrated for the sake of simplicity and understanding, one skilled in the art will appreciate the motion enhancing mechanism 606 may be configured to accommodate a larger number of signs.

This arrangement shown by way of example in FIGS. 7, 8A, and 8B, provides the opportunity to provide more information or advertising to a potentially larger audience. For example, if used by a roadside, information or advertising may be provided to cars and/pedestrians traveling in both directions along the roadway. Additionally, duplicative, complementary, or multiple advertisements may be provided by a single apparatus 600′. The apparatus 600′ may be spun by a user to alternate which sign 602 or 602′ is facing a given direction or to face the signs in various directions. For example, signs 602 and 602′ may both read “Try Jane's Pizza?”, so that cars or pedestrians traveling in various directions can see the signs from different directions and angles. Alternatively, for two signs reading “Want Pizza?” and “Try Jane's,” the apparatus 600′ may be alternately rotated so the each direction of cars or pedestrians sees both signs alternately. The concept of trying Jane's pizza is thus promoted to passers-by reading the question “Want Pizza?” together with a suggested answer “Try Jane's.”

According to yet another alternative, signs 602 and 602′ may have different advertisements such as “Try Jane's Pizza” and “Leroy's Laundromat” and may be alternately displayed to car and pedestrian traffic traveling in various directions. Multiple motion enhancement mechanisms 606 and/or 606′ may be provided at one or more positions along the extended portion 608.

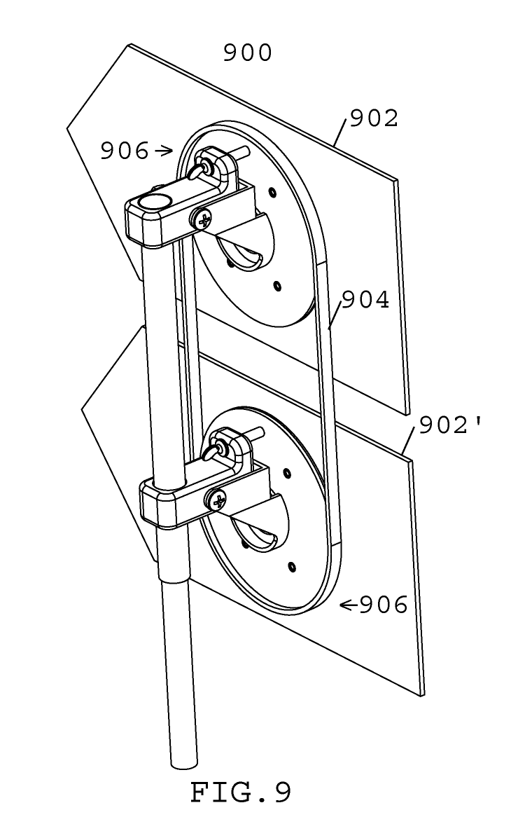

According to the implementation shown in FIG. 9, an exemplary apparatus 900 includes a motion enhancement mechanism 906 that may be duplicated and the motion coordinated such that multiple signs 902, 902′, and so forth may be moved in a coordinated fashion. According to one example, the signs 902 and 902′ may be connected by a mechanism 904 for coordinating movement of the signs. As shown in FIG. 9, the mechanism 904 may be a belt that engages the motion enhancing components 906 coupled to each sign 902 and 902′. It will be appreciated by one skilled in the art that the mechanism for coordinating movement may take any conventional form and the signs 902, 902′, and so forth may face any of various directions.

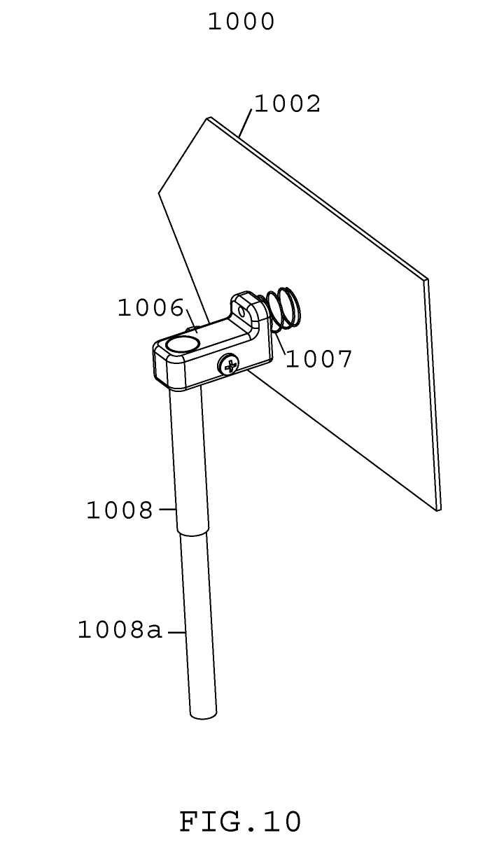

According to the implementation shown in FIG. 10, apparatus 1000, the sign 1002 and/or the motion enhancing mechanism 1006 may further include a spring 1007 to enhance the movement of the sign 1002 relative to the extended portion 1008. Thus, a user may hold the extended portion 1008, and/or extendable portion 1008a, steady with one hand and create motion with the sign 1002 with a second hand. A spring placed between the extended portion 1008 and the motion enhancing mechanism 106 or between the sign 102 and the motion enhancing mechanism 106 may allow the sign to swing side-to-side and/or to bounce up and down as an alternative to, or while, the sign is spinning relative to the handle.

A method of advertising according to the present disclosure includes holding or steadying a motion enhanced sign using a handle 104 and or extended portion 108. The handle 104 may be coupled to an advertising sign 102 by a motion enhancing mechanism 106 as set forth above with regard to FIGS. 1-5. The method further includes moving the sign relative to the handle and/or the extended portion. According to one implementation moving the sign comprises spinning, swinging, tilting, and/or bouncing the sign relative to the handle. In one implementation, the handle and extended portion extend longitudinally in a first direction and moving the sign relative to the handle comprises spinning the sign about an axis that extends in a second direction. The second direction may be perpendicular to the first direction.

### CONCLUSION

Undoubtedly, numerous variations and modifications of the invention will become readily apparent to those familiar with sign advertising. Although implementations of the apparatus and method have been described in language specific to structural features and/or methodological acts, it is to be understood that the system and method defined in the appended claims is not necessarily limited to the specific features or acts described. Rather, the specific features and acts are disclosed as exemplary forms of implementing the claims.

1. An apparatus comprising:
a sign containing advertising or informational content;
an extended portion configured to allow a user to hold or steady the sign; and
a motion enhancing mechanism configured to attach the sign to the extended portion and to allow motion of the sign relative to the extended portion.

2. The apparatus of claim 1, wherein the motion enhancing mechanism comprises a spinning mechanism to allow the sign to spin relative to the handle.

3. The apparatus of claim 2, wherein the extended portion extends longitudinally in a first direction and the spinning mechanism enables the sign to spin relative to the extended portion about an axis that extends in a second direction.

4. The method of claim 3, wherein the second direction is perpendicular to the first direction.

5. The apparatus of claim 2, wherein the spinning mechanism comprised a ball bearing mechanism.

6. The apparatus of claim 1, wherein the motion enhancing mechanism comprises a mechanism to allow the sign to spin, to tilt, or to spin and tilt relative to the handle.

7. The apparatus of claim 1, wherein the extended portion configured to engage a surface to support the weight of the apparatus.

8. The apparatus of claim 7, wherein the extended portion is adjustable to support the weight of the apparatus at different heights relative to the surface.

9. The apparatus of claim 7, wherein the extended portion comprises an offset handle.

10. The apparatus of claim 7, wherein the extended portion comprises an integrated handle along the length of the extended portion.

11. The apparatus of claim 1, further comprising a locking mechanism to releasably lock the sign relative to the extended portion thereby preventing motion of the sign relative to the extended portion.

12. A method of advertising comprising:
holding or steadying a sign containing advertising using an extended portion resting on a surface, the extended portion coupled to the sign by a motion enhancing mechanism configured to allow motion of the sign relative to the extended portion; and
moving the sign relative to the extended portion.

13. The method of claim 12, wherein moving the sign comprises spinning the sign relative to a handle associated with the extended portion.

14. The method of claim 13, wherein the extended portion and handle extend longitudinally in a first direction and spinning the sign relative to the handle comprises spinning the sign about an axis that extends in a second direction.

15. The method of claim 14, wherein the second direction is perpendicular to the first direction.

16. The method of claim 12, further comprising releasably locking the sign relative to the handle to prevent movement of the sign relative to the handle.

17. An apparatus comprising:
a plurality of signs, each sign containing advertising or informational content;
an extended portion configured to allow a user to hold or steady the plurality of signs; and
one or more motion enhancing mechanisms configured to attach the plurality of signs to the extended portion and to allow motion of the plurality of signs relative to the extended portion.

18. The apparatus of claim 17, further comprising a mechanism to coordinate movement of the plurality of signs.

19. The apparatus of claim 17, wherein the plurality of signs face different directions.

20. The apparatus of claim 17, wherein the plurality of signs face a same direction.
